(19) United States
(12) Patent Application Publication
(10) Pub. No.: US 2017/0057307 A1
(43) Pub. Date: Mar. 2, 2017

(54) METHOD OF ADHESION OF RIGID COMPONENTS TO A TIRE

(71) Applicant: THE GOODYEAR TIRE & RUBBER COMPANY, Akron, OH (US)

(72) Inventor: Robert Leon BENEDICT, Tallmadge, OH (US)

(21) Appl. No.: 15/237,720

(22) Filed: Aug. 16, 2016

Related U.S. Application Data
(60) Provisional application No. 62/212,074, filed on Aug. 31, 2015.

(51) Int. Cl. B60C 23/04; B29D 30/06; B29D 30/00

(52) U.S. Cl. CPC B60C 23/0493; B29D 30/0061; B29D 30/0601; B29D 2030/0072

(57) ABSTRACT

The invention provides a method of mounting a device to a tire so that the device is mounted on a flat surface. The invention includes a shaped rubber patch having a flat mounting surface and a doubly curved lower surface. The shaped rubber patch is mounted inside the tire in such a way that the curved lower surface mates to the tire sidewall so that the device can be mounted on a flat surface. Because the curved lower surface of the patch mates with the tire curvature, a better attachment interface is provided.

### FIELD OF THE INVENTION

The invention relates generally to tires and more specifically, to adhering mechanical components to a tire.

### BACKGROUND OF THE INVENTION

It is often desirable to incorporate devices into tires, such as for example, an air maintenance feature within a tire that will maintain correct air pressure within the tire, or a device for monitoring tire parameters such as a tire pressure monitor system. An air maintenance feature typically includes rigid mechanical components such as an air filter, regulator or valve mechanism. These mechanical components must be secured to the tire, and be able to sustain rotational and centrifugal forces. These devices must also be assembled in such a way to minimize the stresses at the bonding interfaces and allow for ease of assembly.

### SUMMARY OF THE INVENTION

The invention provides a method of mounting a device to a tire comprising the following steps: buffing an inside surface of the tire, forming a rubber layer and a rubber extension on a mounting surface of the device, wherein the rubber extension extends past the support frame; applying rubber cement to the mounting surface and then affixing the mounting surface of the device to the inside surface; and then curing the rubber cement.

### BRIEF DESCRIPTION OF THE DRAWINGS

The invention will be described by way of example and with reference to the accompanying drawings in which:

FIG. 1 is a front view of tire and rim assembly with a pump, valve and filter assembly.

FIG. 2 is a cross sectional view of a truck tire;

FIG. 3 is a close up view of the truck tire bead area showing a docking station, a regulator and a filter assembly for communicating with the pump passageway;

FIG. 4 is an exploded view of a regulator and docking station;

FIG. 5 is a perspective view from the below of a docking station and regulator of FIG. 4;

FIG. 6 is a perspective view of the docking station frame.

FIG. 7 is a perspective view of the mold for forming the rubber flange.

FIG. 8 is a perspective view of a tire showing the assembly mounted inside of the tire.

FIG. 9 is a close up view of the regulator assembly and curved patch of FIG. 8.

FIG. 10 is an exploded view of the regulator and curved patch.

FIG. 11 is a perspective view of a patch and a mold for a patch.

### DETAILED DESCRIPTION OF THE INVENTION

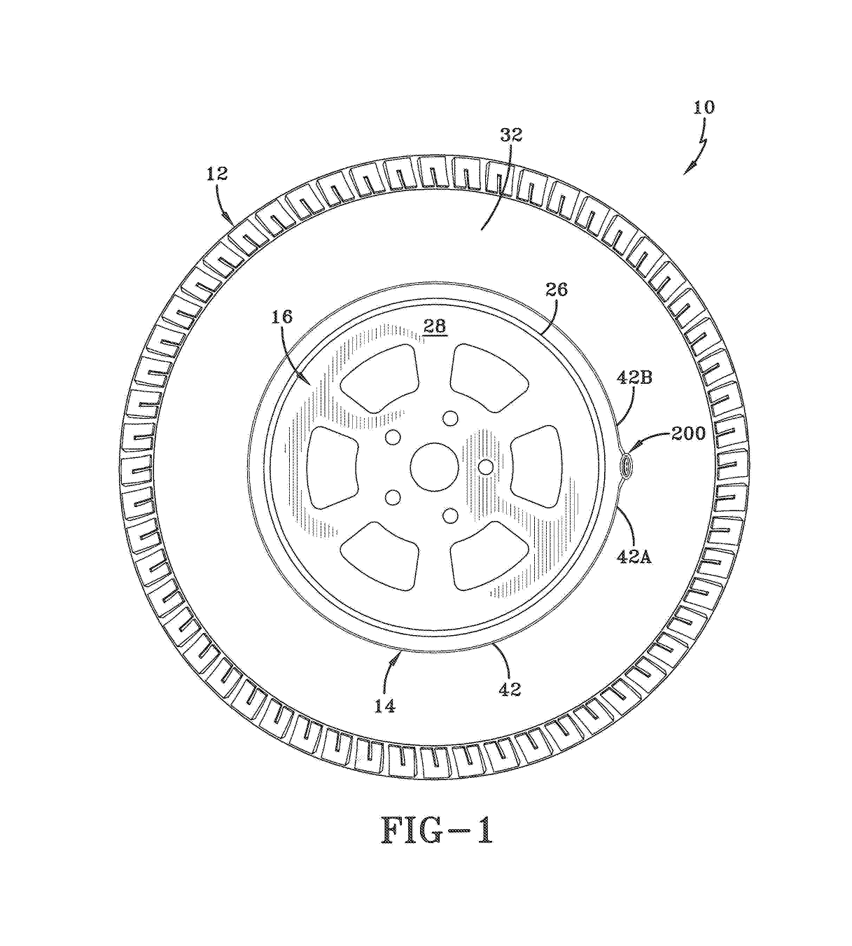

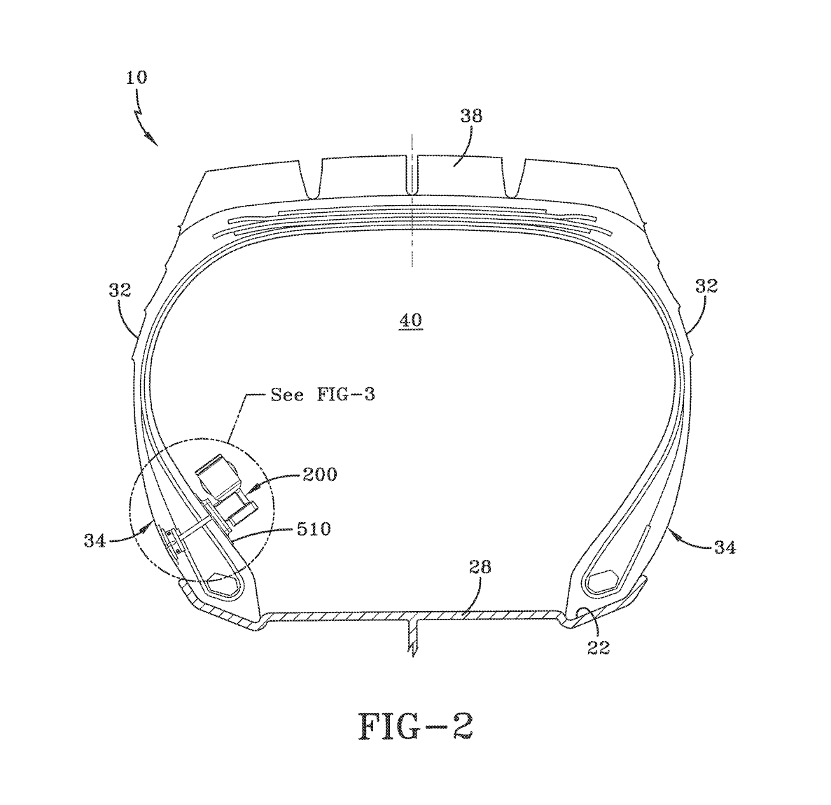

Referring to FIGS. 1 and 2, a tire assembly 10 includes a tire 12, a pump assembly 14, and a tire wheel 16. The tire mounts in a conventional fashion to a wheel having a rim body 28 with rim mounting surfaces 22. An annular rim body 28 joins the rim mounting surfaces 22 and supports the tire assembly as shown. The tire is of conventional construction, having a pair of sidewalls 32 extending from opposite bead areas 34 to a crown or tire tread region 38. The tire and rim 28 enclose an interior tire cavity 40 which is filled with air.

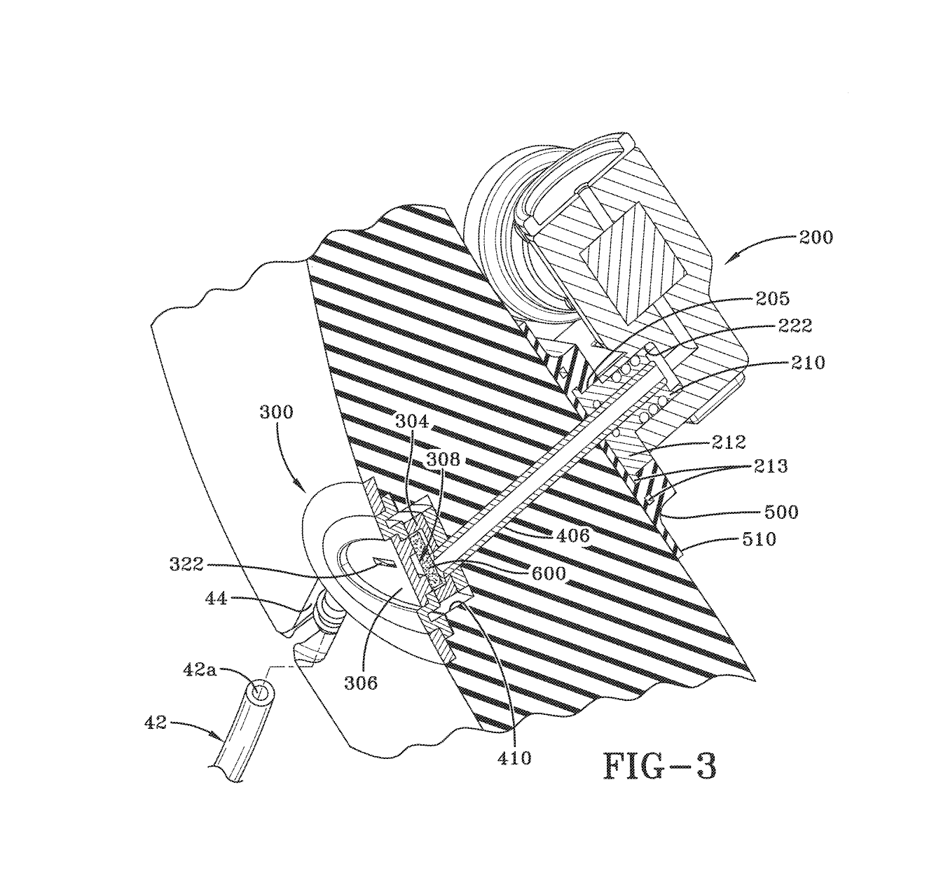

As shown in FIGS. 1 and 3, the tire assembly includes a pump 14 having a pump passageway 42 that is mounted or located in the tire in a channel 44, preferably near the bead region 34 of the sidewall. The pump passageway 42 may be formed of a discrete tube 42 made of a resilient, flexible material such as plastic, elastomer or rubber compounds, and is capable of withstanding repeated deformation cycles when the tube is deformed into a flattened condition subject to external force and, upon removal of such force, returns to an original condition. The tube is of a diameter sufficient to operatively pass a volume of air sufficient for the purposes described herein and allowing a positioning of the tube in an operable location within the tire assembly as will be described. Preferably, the tube has an elliptical cross-sectional shape, although other shapes such as round may be utilized.

The pump passageway itself may also be integrally formed or molded into the sidewall of the tire during vulcanization, eliminating the need for an inserted tube. An integrally formed pump passageway is preferably made by building into a selected green tire component such as a chafer, a removable strip made of wire or silicone. The component is built into the tire and cured. The removable strip is then removed post cure to form a molded in or integrally formed pump air passageway.

Hereinafter, the term “pump passageway” refers either to installed tubes or an integrally molded in passageway. The location selected for the pump passageway within the tire may be within a tire component residing within a high flex region of the tire, sufficient to progressively collapse the internal hollow air passageway as the tire rotates under load thereby conveying air along the air passageway from the inlet to the pump outlet.

The pump air passageway 42 has an inlet end 42a and an outlet end 42b in fluid communication with a regulator or valve assembly 200, as shown in FIG. 3. The regulator assembly is preferably mounted inside the tire. Examples of pressure regulators or valve systems suitable for use with the invention are disclosed in U.S. patent application Ser. Nos. 13/221,231, 13/221,433, 13,221,506 which are hereby incorporated by reference. As shown in this particular example, the inlet end 42a and the outlet end 42b are spaced apart approximately 360 degrees forming an annular pump assembly. However, the inlet and outlet ends may be spaced apart 90 degrees, 180 degrees, etc.

An air filter assembly 300 is positioned on the outer sidewall of the tire, opposite the regulator assembly 200 and in the vicinity of the pump passageways, as shown in FIGS. 2-3. The air filter assembly filters the outside air and communicates the filtered air to the regulator assembly 200 via passage tube 406. One or more layers of filter media 600 is received in the internal cavity 308 of the filter assembly 300. The filter media may be a woven or nonwoven fiber, foam, spun fiberglass, charcoal, or other materials known to those skilled the art. Alternatively, a membrane such as PTFE GoreTex may be used, alone or in combination with the filter media.

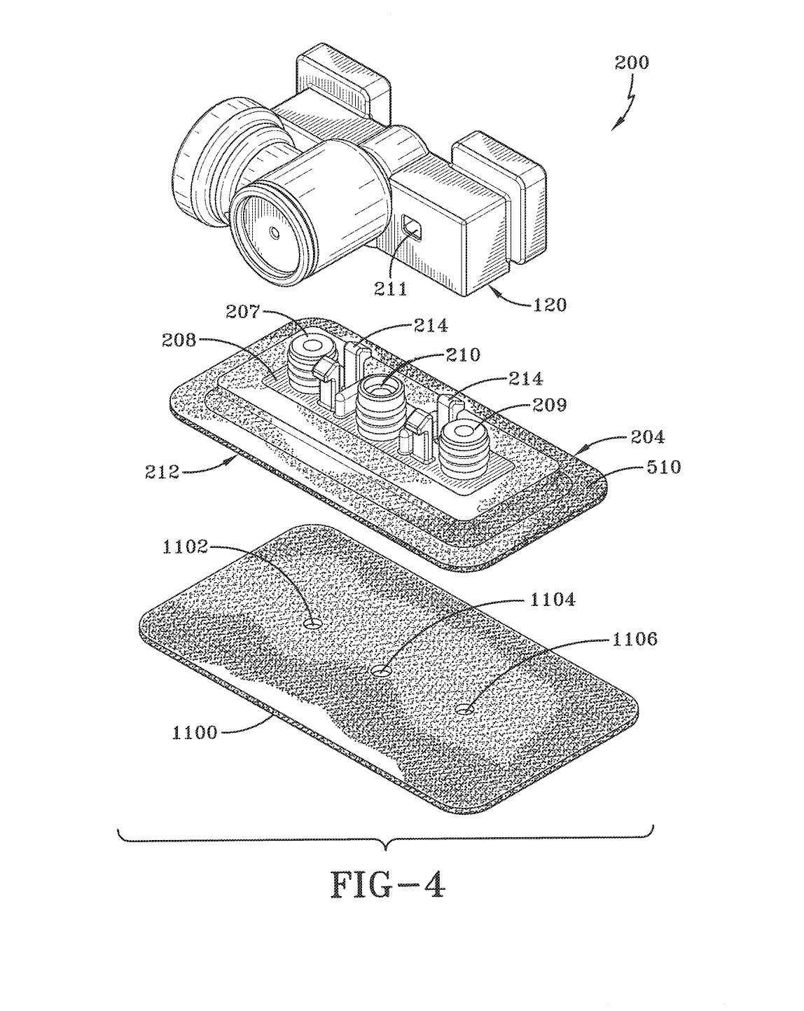

The regulator assembly 200 is shown in FIGS. 4-6. The regulator assembly 200 is operable to control the amount of inlet air to the pump system 42. If the tire cavity pressure falls below a set trigger pressure, the regulator assembly allows filtered air to enter the regulator assembly inlet port 222 through inlet hole 202, and then through to the pump passageway 42. The regulator assembly may allow airflow into the pump system through an air outlet port 210. The regulator assembly also may control the flow of air from the pump into the tire cavity, as well as prevent cavity air from back flowing into the pump passageways.

The regulator assembly 200 is preferably affixed to the inside of the tire, near the bead area. In this embodiment, the regulator assembly 200 is detachably mounted to a docking station 204. The docking station 204 has a lower surface 206 that is permanently affixed to the inside of the tire. The docking station 204 has an inlet port 202 that is in fluid communication with a central air conduit 210, opposite the inlet 202. The central air conduit extends from the upper surface 208 of the docking station to the inlet 202. The central air conduit 210 is in fluid communication with the air filter assembly 300, and communicates filtered air to the regulator assembly inlet 222 as shown in FIG. 3.

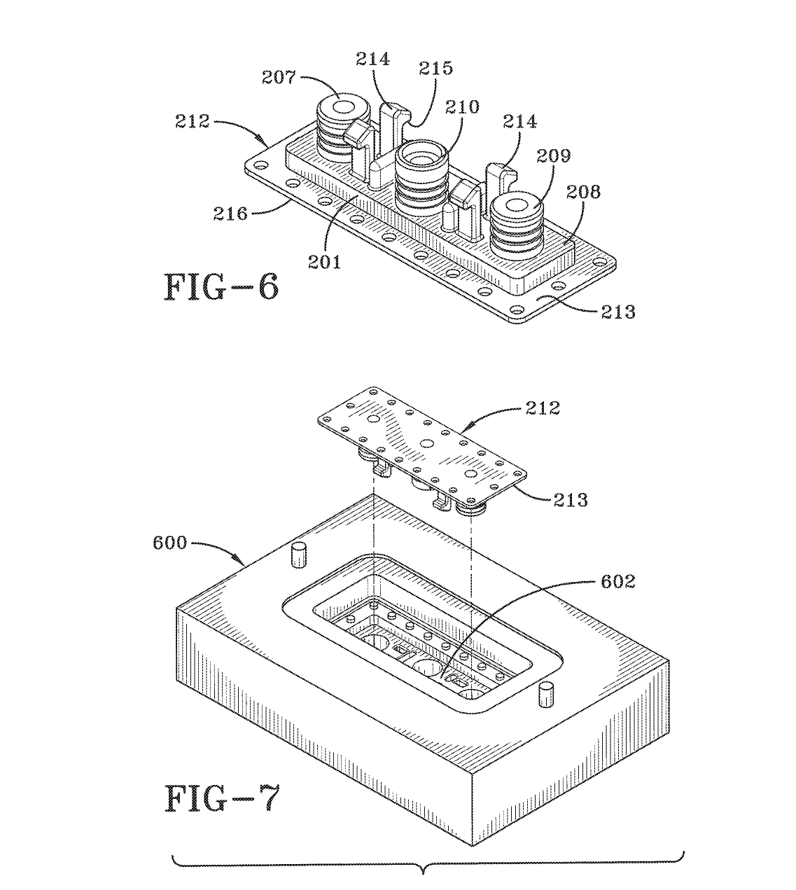

FIG. 6 illustrates the docking station support frame 212 without the rubber encasement. The support frame 212 has an upper surface 208 that connects to the lower surface of the regulator. A plurality of pronged connectors 214 extend from the upper surface and have a tabbed portion 215 that snapped into receptacles 211 inside the regulator. The upper surface of the docking station has a regulator outlet conduit 207 which communicates fluid from the regulator outlet 218 to the pump inlet 42a. The upper surface of the docking station further includes a regulator inlet conduit 209 which communicates pump fluid from the pump outlet 42b to the regulator inlet 220. As shown in FIGS. 3 and 4, the docking station has a rubber layer 500 molded over the support frame. As shown in FIG. 7, the cross-section of the support frame 212 preferably has a flanged surface 213 surrounding the support frame. The rubber layer is molded around the sides of the docking station and along the flanged surface 213 and along the bottom surface 216 of the support frame. As shown in FIG. 4, the rubber layer has a rubber flange or extension 510 which extends outward the support frame. The rubber flange 510 extends past the flanged surface 213 1-3 cm on all sides. Thus the footprint of rubber layer is greater than the footprint of the support frame. The thickness of the rubber layer is in the range of 1-4 mm, preferably 2-3 mm.

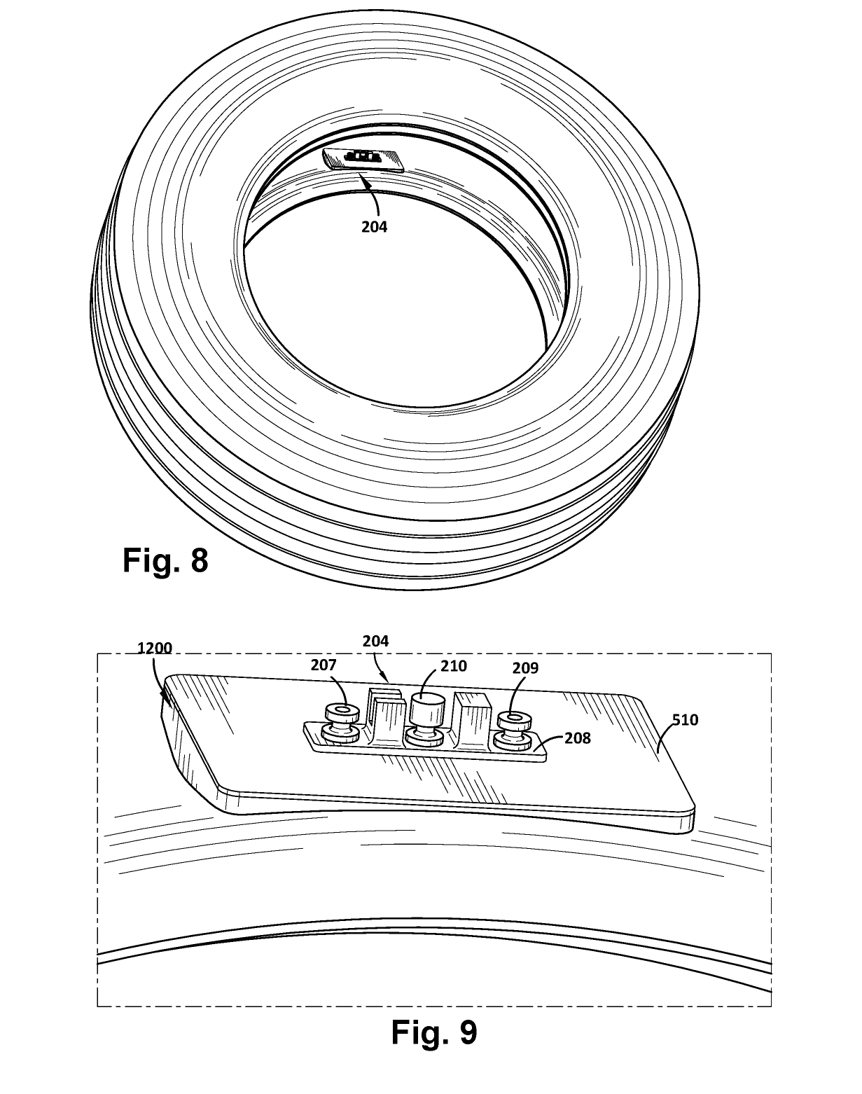

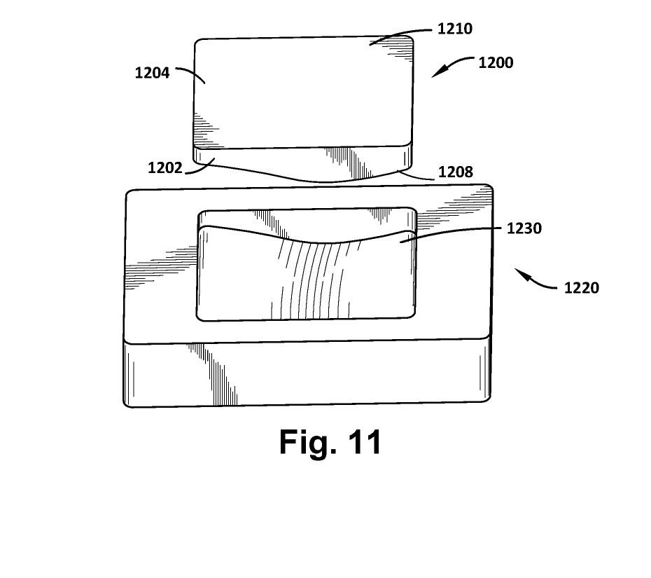

An alternate embodiment of a rubber patch 1200 is shown in FIGS. 8-11. Unlike patch 1100, rubber patch 1200 has a curved lower surface 1202 as shown in FIG. 11 that mates with the tire sidewall curvature at the desired location of installation on the tire sidewall. The curved lower surface 1202 is shaped so that the patch is flat when mounted on the tire sidewall as shown in FIGS. 8 and 9. As shown in FIG. 11, the tire patch thickness varies, and greatly increases from a first end 1204 to a maximum thickness 1208. The curved lower surface 1202 is preferably asymmetrical in shape. The rubber patch 1200 has a flat upper surface 1210. The rubber patch 1200 is formed by shaping the patch in a mold 1230. The curved lower surface 1202 is curved in a first direction along its length so that when seated on the tire inner surface the curvatures mates with the inner surface curvature in the circumferential direction. The curved lower surface 1202 is also curved in a second direction (along its depth) so that when seated on the tire inner surface it mates with the inner tire curvature in the radial direction. The rubber patch 1200 is preferably green rubber, but may be partially or fully cured in the mold 1230. After the rubber patch is formed, the lower surface 1202 of the rubber patch is seated next to the curved inner sidewall of the tire as shown in FIG. 11. Although not shown, the rubber patch may further include holes for communicating fluid from a pump to the regulator.

The following steps are followed to mount the docking station 204 to the inside surface of the tire. These steps could also be used to mount any mechanical device, including the regulator without the docking station. The lower mounting surface 216 and sides 201 including the flanged surface 213 are buffed with abrasive material such as sandpaper. Next the mounting surface and sides of the docking station are pretreated with Chemlock or other suitable adhesive, ensuring the holes 202,203,205 located on the lower surface of the docking station are protected from the application of adhesive. Next, the docking station is placed in a mold 600, so that the upper surface 208 is seated against a lower surface 602 of the mold 600 as shown in FIG. 7. Green rubber or elastomer is placed in the mold to enrobe the lower mounting surface and sides of the docking station with rubber/elastomer and to form a rubber flange on the lower mounting surface. A wide variety of rubbers would work, such as sidewall compound, cushion gum, apex etc. The mold forms an extension or thin layer of rubber wherein the periphery of the rubber flange extends 2-3 cm outward of the mounting surface. Preferably, the thickness of the rubber is about 1 to 2 mm. The coating of rubber may be cured or partially cured about the docking station housing. The rubber lower mounting surface and sides, including the rubber flange is buffed.

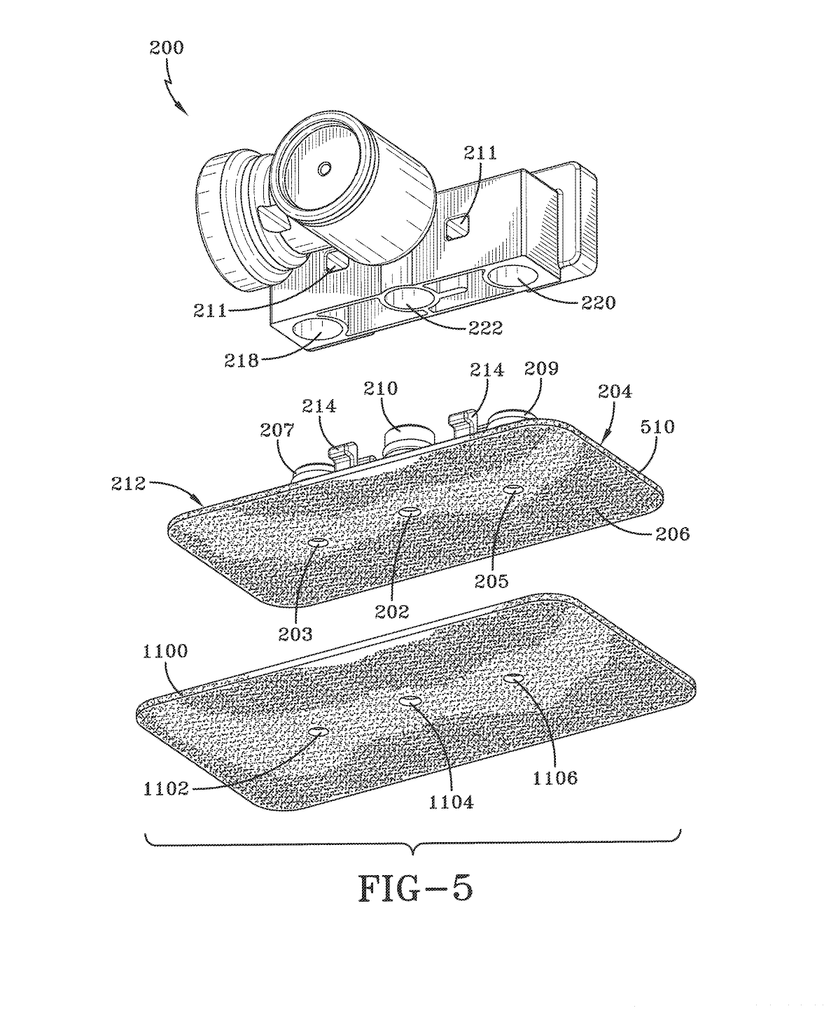

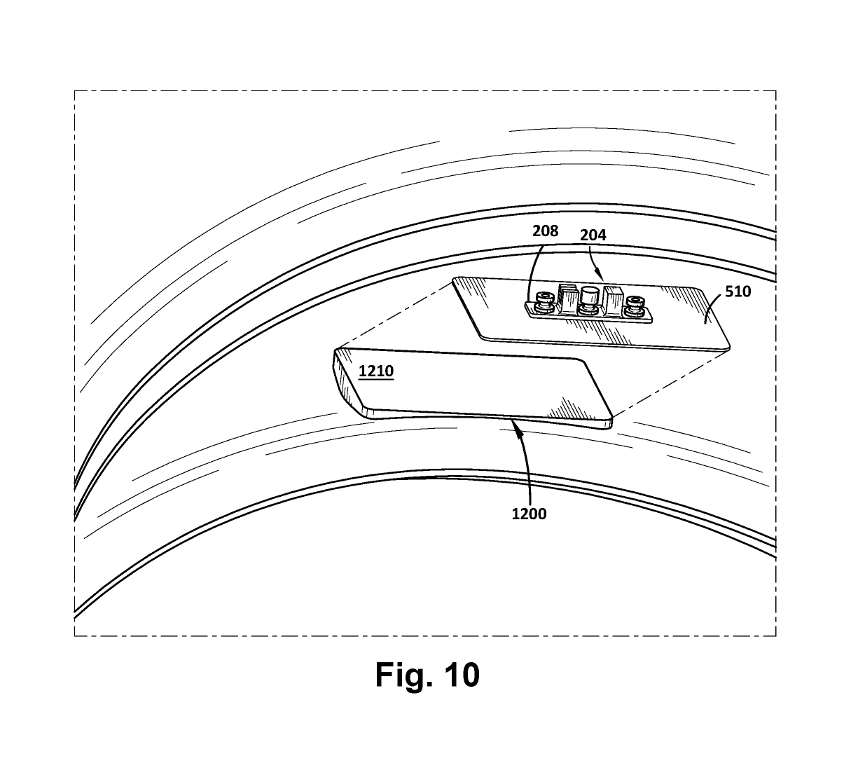

Next, the inner liner surface of the tire is buffed. Depending upon the adhesion strength required, the inner tire surface may need to be buffed down to expose the better bondable material i.e. the ply-coat, removing the inner liner. A rubber patch 1100 or 1200 is used to secure the docking station to the tire inner liner surface as shown in FIG. 9. The docking station 204 is affixed to the tire sidewall as shown in FIGS. 2 and 8. The rubber patch 1100/1200 is preferably larger in size than the mounting surface of the docking station. The rubber patch 1100/1200 is coated with a suitable adhesive on both sides and then inserted onto the inner surface of the tire as shown in FIG. 10. The patch 1100/1200 may require holes that are aligned with holes of tire and the device to be mounted. One suitable adhesive is Fast Dry Self-vulcanizing Cement made by the Rubber Patch Company. The patch 1100/1200 is then stitched. Next, the device mounting surface is mounted over the rubber patch 1100/1200 as shown in FIGS. 5 and 10, ensuring the rubber patch holes are aligned with the device holes and any tire holes. The device is then clamped to the tire, and then allowed to cure at ambient temperature or with heat, depending upon the adhesive selected.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of mounting a device to a tire comprising the following steps:
a. buffing an inside surface of the tire,
b. providing a rubber patch having a flat upper mounting surface and a lower curved surface in a first direction;
c. coating the rubber patch on both sides with rubber cement and inserting the green rubber patch onto the buffed inside surface of the tire;
d. affixing a mounting surface of the device to the green rubber patch;
e. curing the tire.

2. The method of claim 1 wherein the rubber patch is formed of green rubber.

3. The method of claim 1 wherein the lower curved surface is asymmetrical.

4. The method of claim 1 wherein the lower curved surface mates with the sidewall of the tire so that the upper surface is horizontal.

5. The method of claim 1 wherein the rubber patch is curved in a second direction.

6. The method of 1 wherein the innerliner is removed at the mounting location.

7. A method of mounting a device to a tire comprising the following steps:
a. buffing an inside surface of the tire,
b. forming a rubber layer and a rubber extension on a mounting surface of the device, wherein the rubber extension extends past the support frame;
c. providing a rubber patch having a curved lower mounting surface to the mounting surface and then affixing the mounting surface of the device to the inside surface; and then
d. curing the rubber patch and the cement.

8. A rubber patch for a tire having an upper surface and a lower mounting surface, wherein the lower mounting surface is curved in a first direction and curved in a second direction, wherein the upper surface is flat.
